(19) United States
(12) Patent Application Publication
(10) Pub. No.: US 2010/0325139 A1
(43) Pub. Date: Dec. 23, 2010

(54) Service Provider Management Console

(75) Inventors: Iain Frew, Duvall, WA (US); Lingan Satkunanathan, Kirkland, WA (US); Eric B. Watson, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/486,777

(22) Filed: Jun. 18, 2009

(51) Int. Cl. G06F 17/30; G06F 3/048; G06F 15/16

(52) U.S. Cl. 707/769; 715/764; 709/206; 707/770; 707/759; 707/812

(57) ABSTRACT

A service provider management system may consolidate multiple functions and multiple service providers for those functions using a user interface system with a common schema. Each service provider may comply with a function specific schema, and some service providers may include extensions to the schema. The user interface system may present a list of service providers. When a specific service provider is selected, a list of available tasks along with current data about the service provider may be presented. The service provider management may integrate with local databases for populating information used by a service provider. One embodiment may be used to manage services across a network of computer devices, such as managing multiple computing devices and multiple users within a local area network.

### BACKGROUND

Many computer systems and network computer environments may have many operating services. Examples of services may be internet connection or other network connectivity services, backup services, mail services, and many others. Configuring and managing those services can be cumbersome, even more so when those services are provided by different service providers.

In many cases, a particular service may be available from multiple service providers. For example, electronic mail services may be available from a locally hosted mail system, a mail server available through a local area network, and multiple cloud-based or Internet based mail hosting services.

### SUMMARY

A service provider management system may consolidate multiple functions and multiple service providers for those functions using a user interface system with a common schema. Each service provider may comply with a function specific schema, and some service providers may include extensions to the schema. The user interface system may present a list of service providers. When a specific service provider is selected, a list of available tasks along with current data about the service provider may be presented. The service provider management may integrate with local databases for populating information used by a service provider. One embodiment may be used to manage services across a network of computer devices, such as managing multiple computing devices and multiple users within a local area network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system for managing services.

FIG. 2 is a diagram illustration of an embodiment showing an example of a user interface.

FIG. 3 is a flowchart illustration of an embodiment showing a method for preparing a user interface.

FIG. 4 is a flowchart illustration of an embodiment showing a method for operating a user interface.

FIG. 5 is a flowchart illustration of an embodiment showing a method for updating a user interface for a selected service provider.

### DETAILED DESCRIPTION

A service provider management system may manage many different services from many different service providers through a consolidated user interface. The management system may use a schema for each managed function, and each service provider may comply with the schema and, in some cases, provide additional features.

The user interface may present multiple service providers in a single place where a user may manage multiple service providers, including currently used service providers and other service providers that are available for use. Some embodiments may query a remote catalog server to download and present available service providers.

An example use scenario may include managing client devices in a corporate network. In such an environment, many client devices such as desktop and laptop computers may be connected to and use various services, such as backup systems, messaging systems, update services, and other services. In some cases, services may be configured on a per-device basis, while in other cases, services may be configured on a per-user basis. An administrator may manage the client devices by provisioning and configuring the various services for each client device, user, or the entire network.

In the scenario, multiple services may be available for email distribution, for example. Two or more local email servers may be available, as well as remotely hosted or cloud based email services. The administrator may be presented with all of the available services for the enterprise in a single user interface, as well as other available services that are not currently being used. The administrator may be able to interact with and manage each service through a centralized and uniform user interface.

The service provider management system may use a schema to define supported actions that may be launched from the user interface, as well as data used or provided by the various service providers. Each service that is managed with the management system may comply with the schema. By using a common schema, many different service providers may make their service available by complying with the schema.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

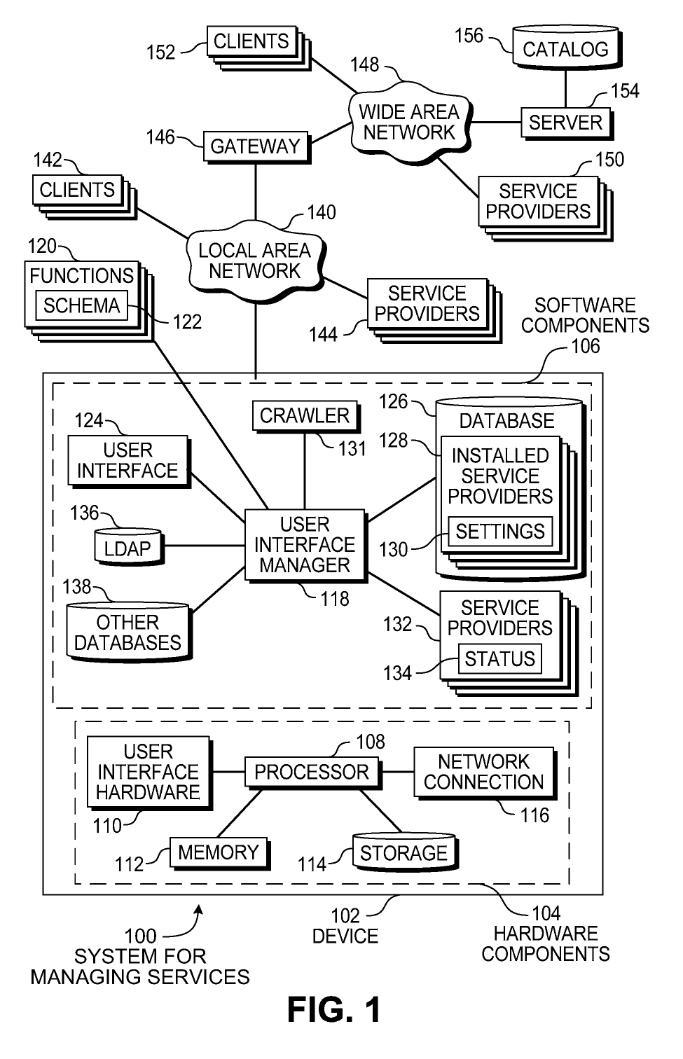

FIG. 1 is a diagram of an embodiment 100 showing a service provider management system. Embodiment 100 is a simplified example of a management system that uses a single user interface to manage many different types of services.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

The service provider management system may be used to manage various applications and services in a computing environment. The management system may configure, edit, and provision services to users on a local device, or may be used to manage services across multiple devices and users on those devices.

The management system may allow a system administrator to manage widely disparate applications and services in a unified user interface. Because the service providers conform to a schema, multiple alternative service providers may be presented to the administrator. The alternative service providers may be service providers that are available to perform a specific function but are not yet installed or configured.

Embodiment 100 illustrates the functional components of a system that may manage multiple service providers. A service provider may be a locally running application, an application running within a local area network, or other remotely available service that provides some function used by a client device. In many cases, multiple service providers may be available to provide a desired function to a client device.

The term “function” is used to denote a high level class, group, or genre of applications or services that may be used by a client device or client user. The term “function” is used to classify similar applications or services into a group for management purposes. In some cases, applications or services in the group may be interchangeable, and in other cases, the applications or services in the group may be only casually related but neither depend on or are interchangeable with other applications or services in the group.

In a business enterprise, the functions may include messaging services, computer backup services, network connection services, application distribution services, update services, or other groupings of applications and services. Within each function, multiple service providers may be available. For example, messaging services may include locally available mail servers as well as web-based or remote mail services.

For a consumer device, the functions may include social networking services, web hosting and blogging services, photo library services, video or music subscription services, or any other type of function. Other devices may have different types of functions.

The term “service provider” is used to denote any application, service, server, or other system that may conform to a schema used to define a function. The schema for a function may define data that are supplied to and received from a service provider, as well as a minimum function set that each service provider may perform. In some cases, a single service provider may provide services that conform to two or more function schemas.

The service provider management system may present multiple service providers for each function within a user interface. The user interface may allow an administrator to perform a set of actions with the service provider, which may include launching a separate user interface for the service provider. In many embodiments, the service provider management system may allow an administrator to perform certain basic operations from the management system user interface, but some operations may be performed within a service provider user interface. In a typical embodiment, simple or generic actions may be performed directly from the service provider user interface while more complex or interactive actions may be performed through a user interface provided by the service provider.

Complex or interactive actions may be performed through a service provider user interface so that the user may intuitively know the responsible party should the user wish to contact help desk or seek some assistance. The service provider management system may operate as a central point from which an administrator may manage multiple service providers. However, the service providers may be created, owned, managed, and maintained by a different organization than the management system. By using a separate user interface provided by the service provider for complex actions, the user may direct help related issues to the service provider rather than the manufacturer or supplier of the management system.

Embodiment 100 illustrates functional elements of a service provider management system that may be implemented in a network environment. The device 102 may be a management device such as a server computer within a local area network, and may manage service providers that interact with various client devices within a local area network or a wide area network. A typical use scenario may be to manage client devices within an enterprise such as a business or corporation. In such a scenario, an administrator may manage many hundreds or thousands of devices and users through a service provider management system.

In some embodiments, the service provider management system may be used to manage service providers for the device 102. In such embodiments, the service provider management system may be used to manage the functions of a local device for one or more users. For example, a home computer, laptop computer, cellular telephone, netbook computer, or other device may have a service provider management system for centrally managing various applications and services for the device.

The service provider management system may manage services that are device dependent as well as user dependent services. A device dependent service may be one that is operable on specific devices and may be used by multiple users of the device. A user dependent service may be one that is configured for specific or individual users. In some cases, a user dependent service may be configured for a specific user on a specific device. In other cases, a user dependent service may be configured for a specific user regardless of the device. In such cases, the service may ‘follow’ the user from one device to another, or otherwise be available to the user on multiple devices.

For example, a device dependent service may be a backup and restore system, whereas a user dependent service may be an email system. The backup and restore system may backup all of the contents of a storage mechanism attached to the device, and may not be configured for individual users. In comparison, an email system may be configured for an individual user where the user may access an email mailbox or other features from any device.

In some cases, a service provider may be configured for a specific user and a specific device. For example, a user's personal data stored on a specific device may be backed up using a backup service. In another example, a local mailbox on a specific device may be configured for a specific user.

The device 102 may have hardware components 104 and software components 106. The device 102 is an example of a common personal computer or server computer. The hardware components 104 may include a processor 108 that may execute the software components 106. In a simple embodiment, the processor 108 may be a single, general purpose microprocessor. In other embodiments, the processor 108 may be a multicore processor or other system with two or more processors.

The processor 108 may have memory 112 that may be volatile, random access memory. Additionally, storage 114 may be used as nonvolatile storage for offline information. In a typical personal or server computer, the storage 114 may be a hard disk storage device, solid state nonvolatile storage device, or other storage system.

0411 The hardware components 104 may include a network connection 116 that may allow the device 102 to connect to and communicate with other devices. In some embodiments, several network connections 116 may be present. A typical desktop or server computer may include a hardwired Ethernet or other hardwired connection. Some devices may include wireless connections including WiFi, WiMAX, UWB, Bluetooth, cellular telephony, or other wireless connection mechanism.

The software components 106 are illustrated as several functional elements. In many embodiments, software systems may perform the functions of the elements as either standalone software components or as functions that may be performed by an application. In some cases, two or more functional elements may be performed by a single application.

The architecture illustrated in embodiment 100 is merely one example of the functional elements that may be used in a service provider management system. Other embodiments may have the various functions performed by two or more separate software or hardware elements, and some embodiments may implement some of the software components 106 in hardware, and some of the hardware components 104 in software. The example of embodiment 100 is presented to illustrate the functional components of a service provider management system without limiting any embodiment to the architecture shown.

A user interface manager 118 may be a software component that performs much of the operations of managing service providers. The user interface manager 118 may use various functions 120, each of which may have a schema 122 to define the interface for various service providers. The functions 120 are classifications or groupings of service providers, each of which may conform to a schema 122 defined for the function.

The schema 122 may define data that may be transferred to and from a conforming service provider, along with various functions that may be implemented by the service provider. In some cases, the functions defined by the schema may be mandatory functions, while in other cases, the functions defined by the schema may be optional functions. Some service providers may also define additional functions that are specific to an individual service provider.

The user interface manager 118 may create a user interface 124 through which a user may interact with the user interface manager 118. An example of a graphical user interface is illustrated later in this specification. The user interface 124 may display service providers grouped according to function, and may also display actions that may be performed with the service providers. In some embodiments, the user interface 124 may include current data from the service providers.

When the user interface manager 118 creates a user interface 124, the user interface manager 118 may display current installed service providers as well as other service providers that are not installed.

The user interface manager 118 may reference a database 126 that may include the installed service providers 128 and the various settings 130 for each installed service provider. The database 126 may be used to quickly gather all of the installed service providers and present those service providers in the user interface 124.

The settings 130 may be any type of information or data that relate to the installed service providers 128. For example, the settings 130 may include configuration settings, status information, or other information. In some embodiments, a crawler 131 may query installed service providers to gather the settings 130.

In some cases, the settings 130 may be static information that is rarely changed over time. For example, a setting for a backup service may include an address for a backup location. Such a setting may be configured when the service is initialized, but may be changed only on rare occasions.

In other cases, the settings 130 may be dynamic information that may be updated when the user interface 124 is generated and, in some cases, updated periodically thereafter. In such cases, the crawler 131 may query the service provider to retrieve specific information used in the user interface 124. In some embodiments, the crawler 131 may operate as a background process to periodically update the database 126 even while the user interface manager 118 may not be operational.

The service providers 132 may be locally running services that may be managed using the user interface manager 118. The local service providers 132 may be applications, services, programs, devices, or other locally accessible services on the device 102. For example, the device 102 may be a server computer for a local area network 140, providing various services to client devices 142 on the local area network 140. The services may be provided using locally executing service providers 132.

In many cases, the service providers 132 may have status information 134 that may be queried and displayed in the user interface 124 at various times. In some embodiments, the crawler 131 may periodically query the service providers 132 to retrieve the status information 134.

When the user interface manager 118 interacts with a service provider, such as the locally executing service providers 132, the user interface manager 118 may populate various data fields that are transmitted to the service providers. For example, a Lightweight Directory Access Protocol (LDAP) database 136 may be queried to determine various parameters about users, devices, and other directory services.

The LDAP database 136 is an example of a directory services database that may contain a logical grouping of users and computers in a hierarchical database. In many LDAP databases, a domain may be defined in which various users and computers may be defined. Many LDAP databases may be extended to include entries for various objects, some of which may be service providers. Some embodiments may use LDAP-like databases. Many software providers have developed LDAP-like databases for managing different network systems.

In one use scenario, a service provider may be configured with credentials for accessing certain data on a client device. In such a case, the user interface manager 118 may gather the credentials from an LDAP database 136 and pass the credentials to the service provider at some point.

The user interface manager 118 may be able to gather information from various other databases 138. For example, a mail management database may include email addresses or other information that may be used by a service provider. The information may be passed to a service provider.

The data passed to a service provider may be defined in a schema for a particular function. In many cases, certain service providers may use credentials and other information from a directory services database or other database to setup a user account.

In one use scenario, an administrator may wish to setup an email account for an employee using a remotely hosted mail service. In the user interface 124, the administrator may view several email service providers, including locally hosted email services as well as remotely hosted email services.

In the scenario, the administrator may select a remotely hosted email service with which a company-wide account is already established. When the administrator selects the remotely hosted email service and initiates a “new user” action, the user interface manager 118 may query the LDAP database 136 to retrieve administrator credentials and user credentials. The administrator credentials may be used to authenticate the administrator with the remotely hosted email service, and the user credentials may be used to establish the user's identity with the remotely hosted email service. After the new user is configured, the user may access the remotely hosted email service using the same credentials used to login to the company network.

The service provider management system may manage services that are consumed by the device 102 as well as clients 142 that are available over a local area network 146. One such use scenario may be managing client devices and users within a home network or an enterprise network.

In some embodiments, the service provider management system may manage services that are consumed by clients 152 available over a wide area network 148. In some cases, the wide area network 148 may be the Internet. One such use scenario may be to manage mobile devices such as smart cellular telephones. An administrator may use a service provider management system to provision services to individual smart cellular telephones or groups of smart cellular telephones across the Internet.

In many cases, a service provider may be attached to a local area network 140, such as service providers 144. An example may be various services provided by a local server, such as a network backup system, email services, file sharing services, user access services, application sharing services, group policy services, locally managed update services, status monitoring services, storage services, or other services. Other examples may be game hosting services, Internet access and filtering services, network search services, database services, distributed computing services, time synchronization services, calendar and address book services, performance monitoring services, communications services, facsimile services, mainframe applications, print services, naming services, or other shared services. In a typical home network or small business network, a service may be provided by a single device such as a server computer, or multiple servers where each server handles several different services. In some cases, two or more servers may provide the same service.

Other service providers may be available through a wide area network 148, such as the service providers 150. In many cases, the service providers available over a wide area network 148 may be provided through large clusters of servers. Such clusters may have load balancing and other management functions that allow the services to have very high availability. In many cases, the same services mentioned above for local area network services may be provided through a wide area network connection. Additionally, some services, such as social networking services, distributed processing, and others, may take advantage of the connected yet dispersed nature of the Internet.

In many embodiments, a remote server 154 may manage a catalog 156 of available service providers. The catalog 156 may include listings of any available service provider that meets a specific schema. In some embodiments, a user interface manager 118 may query the catalog 156 and download several available service providers. The available service providers may be presented along with current installed service providers in a user interface. A user may browse alternative service providers that may meet the basic schema and provide a similar service to any service provider that is already installed. In cases where no service providers are already installed, the user may browse several available service providers.

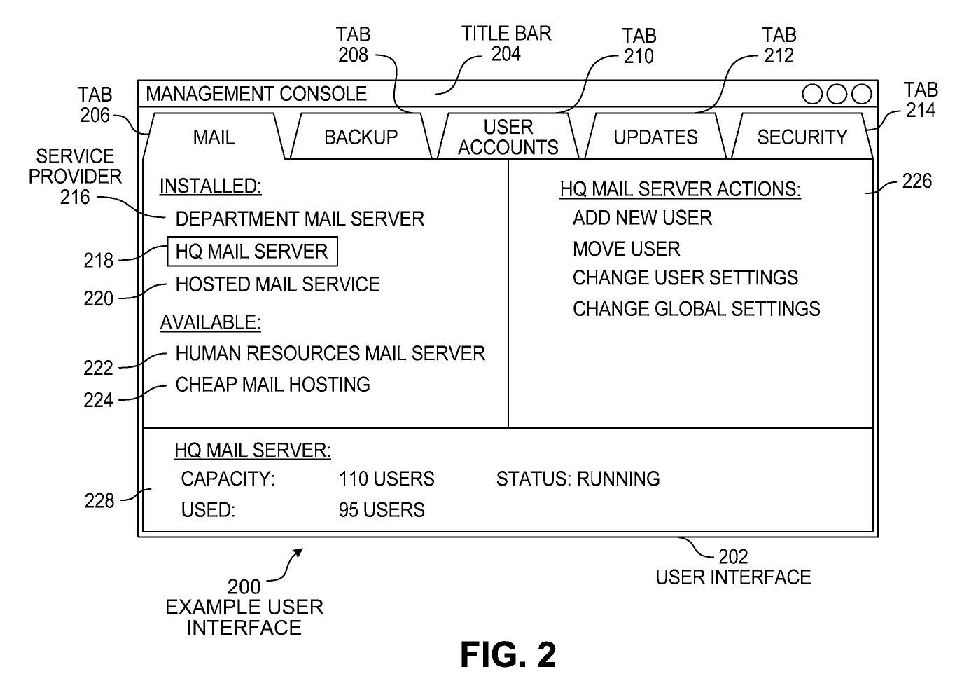

FIG. 2 is a diagram illustration showing an embodiment 200 with an example user interface. Embodiment 200 is an example of merely one layout for a user interface that may be created by a service provider management system, and highlights some of the features that may be included in various embodiments.

Embodiment 200 is an example of a user interface 202 that may be displayed on a graphical user interface device, such as a computer monitor. In many embodiments, the user interface 202 may be presented in a window on a monitor. In a typical window, a title 204 may be presented at the top of the user interface 202.

The user interface 202 illustrates several aspects of a service provider management system. The service provider management system may group several service providers by functions. In the embodiment 200, the functions may be represented by the tabs 206, 208, 210, 212, and 214. A user may interact with the user interface 202 to select one of the various tabs to access service providers that provide the function defined by that tab. In the embodiment 200, the mail tab 206 is selected and various mail related service providers are illustrated.

Service providers 216, 218, and 220 are illustrated as currently installed, and service providers 222 and 224 are illustrated as available. Service providers 222 and 224 may not yet be installed, but may meet the minimum schema defined for all mail related service providers.

Alternative service providers, such as service providers 222 and 224, may be identified by performing a query to a remote catalog server and downloading a list of available service providers. The available service providers may be selected, configured, and used if a user wishes.

Embodiment 200 illustrates installed service providers separately grouped from available or uninstalled service providers. The segregation of the two groups of service providers may highlight the current installed service providers. The currently installed service providers will be the managed much more often than would new service providers be configured. In some embodiments, separating the currently installed service providers from the uninstalled service providers may minimize the potential of a user inadvertently selecting an uninstalled service provider.

The installed service providers may represent both locally hosted and remote service providers. The installed service providers 216, 218, and 220 are illustrated as “Department Mail Server”, “HQ Mail Server”, and “Hosted Mail Service”. In the example of embodiment 200, the “Department Mail Server” may represent a locally hosted mail service, such as a mail service that operates on a server within a local area network. In some cases, the department mail server may be the same device that is hosting the user interface 202. The “HQ Mail Server” may represent a locally hosted mail service that is available through a wide area network connection to another local area network that contains the headquarters mail server. The “Hosted Mail Server” may represent a mail service that is located off premises, such as a subscription service that may be provided by a third party.

The available service providers may be both locally hosted and remote service providers. The available service providers 222 and 224 are illustrated as “Human Resources Mail Server” and “Cheap Mail Hosting”. The service provider “Human Resources Mail Server” may be another mail server that is locally hosted within a company, but may not yet be installed or configured. The service provider “Cheap Mail Hosting” may be a third party mail service. In some cases, a third party mail service may include an advertisement or other explanation for the third party service provider.

In the user interface 202, the service provider 218 is illustrated as highlighted. Service provider 218 is the “HQ Mail Server”. Because the HQ Mail Server is selected, a set of actions appropriate to the HQ Mail Server is presented in box 226, and the status of HQ Mail Server is presented in box 228.

The set of actions in box 226 may be actions that may be launched from the user interface 202 that interact with the selected service. A schema may define the actions and various data components that are consumed and supplied by the service provider for the actions. In many cases, a service provider management system may gather much of the data and transfer the data to the service provider without user interaction.

For example, many of the actions in bock 226 may use administrator credentials to authenticate the action. In some cases, other data may also be transmitted o the service provider, such as individual user credentials, device credentials, network addresses of devices or services, configuration settings of other services, or any other data. When an action is launched, a service provider management system may query various databases, services, configuration files, or other sources for data that may be formatted or transformed to comply with the schema, then transmit the data to the service provider. In the example of administrator or user credentials, a service provider management system may query an LDAP database to gather the credentials.

In many embodiments, a minimum set of actions may be defined within the schema for a particular function. Some embodiments may permit additional functions to be defined by a service provider. Such additional functions may be presented when the particular service provider is selected and highlighted.

Some embodiments may present context sensitive actions when a particular service provider is selected and highlighted. The context sensitive actions may depend on the status of the service provider, and may be stored in a service provider database, such as database 126 in embodiment 100. For example, highlighting an uninstalled service provider may present actions such as “Set up Administrator Account” or “Install Service”. Once the service is installed and an administrator account is set up, the set of actions may include “Add New User”. In another example, an error or alert in the HQ mail server may cause an action such as “View Error Alert” to be presented, but such an action may be omitted when no such error or alert may be present.

Some embodiments may include a data box 228 that may display data or other information about a highlighted service provider. The data may be static data or dynamic data. Static data may be any parameter, setting, or item that is configured but unlikely to change. Such data may be queried when a user interface is created, but generally not updated. Dynamic data may be queried after the user interface is created, and may be updated periodically or when the data changes while the user interface is being displayed.

The embodiment 200 is merely one configuration of an embodiment for a user interface for a service provider management system. Other embodiments may have different layouts and may use different user interface mechanisms for displaying and selecting different components of the user interface.

The user interface of embodiment 200 is illustrated as if the service provider management system were a standalone application. In some embodiments, the functions described for the service provider management system may be incorporated into other applications, which may have additional functionality and additional components in a user interface.

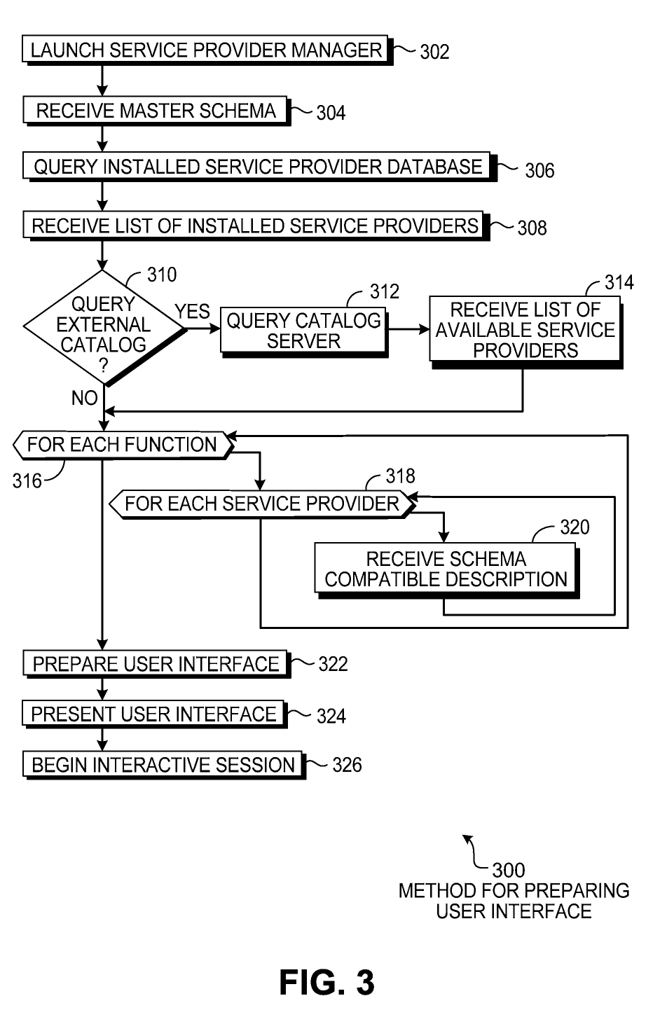

FIG. 3 is a flowchart illustration of an embodiment 300 showing a method for preparing a user interface. Embodiment 300 is a simplified example of a method that may be performed by a user interface manager in gathering information that is displayed in a service provider management system user interface, an example of which may be the user interface of embodiment 300. Presented later in this specification, embodiment 400 illustrates an embodiment of a method for operating the user interface, and embodiment 500 illustrates an embodiment for updating the user interface when a service provider is selected.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 illustrates several steps that may be performed to prepare a user interface for display. Using a schema as a guide, installed service providers and other available service providers are gathered together. The descriptions of the service providers may be presented in the user interface. After the user interface is presented, the operations of embodiment 400 may be performed.

The service provider manager may be launched in block 302. The service provider manager may be a single interface from which several service providers may be selected, configured, and otherwise managed. The service providers may be any type of service, application, device, or other mechanism through which a function may be performed. The service provider manager may display data from the service providers, and may also collect data from various sources, where the collected data may be transformed into a schema-compatible format and transmitted to a service provider to perform a selected action.

In many embodiments, the service provider management system may be an application that operates on a computing device. In some cases, the user interface for the application may be delivered across a network connection and viewed from a second device. In one such embodiment, the user interface may be defined using HTML or other user interface description language. When defined using HTML, an interactive user interface may use a browser to display and collect data.

The master schema may be received in block 304. The schema may define various parameters with which the various service providers may comply. In many embodiments, the schema may be defined for individual functions, where all of the service providers for a specific function may comply with the action and data definitions for the function. Each function may have specific minimum actions that the service provider supports, as well as optional actions that a service provider may or may not support. In some cases, a service provider may supply actions that are specific to the service provider in addition to other actions defined in the schema.

The schema may define data that may be supplied to the service providers and data that may be received from the service providers. The data may be defined by data type, format, or any other definition.

In some embodiments, a single schema may be defined for an entire service provider management system. In such an embodiment, the single schema may have separate sections for individual functions. In other embodiments, each function may have individual schemas defined for the function.

Some embodiments may be extensible to allow additional functions to be supported. By modifying the schema or adding a separate function schema, the service provider management system may be extended to support additional functions.

In block 306, an installed service provider database may be queried. The installed service provider database may be a repository that stores installed service providers, and in some cases may also store configuration or setting information about any installed service provider. In some embodiments, the installed service provider database may be a configuration file, such as an XML file, that is serial in nature and human readable. Other embodiments may store configuration information in an LDAP type database, a relational database, or some other mechanism. In some embodiments, the installed service provider database may be maintained on a remote server, which may also serve as a catalog server for alternative service providers.

In block 308, a list of installed service providers may be received.

In some embodiments, external catalog may be used to locate alternative service providers. If such a query may be made in block 310, the catalog server may be queried in block 312 and a list of available service providers may be received in block 314.

Alternative service providers may be any uninstalled service provider. In some embodiments, a remotely hosted service may maintain a catalog of service providers. In such embodiments, the service providers may be third party services that may be free or may be available through a subscription.

In some embodiments, a catalog server may be maintained within an enterprise or corporate network. Such a server may have a crawler that may search for available services within a local area network and add the services to a catalog from which a service provider management system may retrieve available services within the corporate network.

Some embodiments may have an option for performing an external query in block 310. In some cases, the option may be a configuration item that may be set and stored, while in other cases, a user may be queried as to whether to perform a catalog query.

If the query is not performed in block 310, or after block 314, a complete list of service providers may be defined. For each function in block 316, and for each service provider within the function in block 318, a description may be determined in block 320. The description in block 320 may be compatible with the schema for the particular function.

In block 322, the user interface may be prepared and the user interface may be displayed in block 324. The user interface may incorporate the descriptions received in block 320.

In many embodiments, a user interface may be configured to display one of the functions and select a default service provider for the selected function. In some embodiments, the displayed function and service provider may be the last function and service provider displayed from a previous use of the user interface.

In block 326, the interactive session may begin in block 326. The interactive session may be described in embodiment 400.

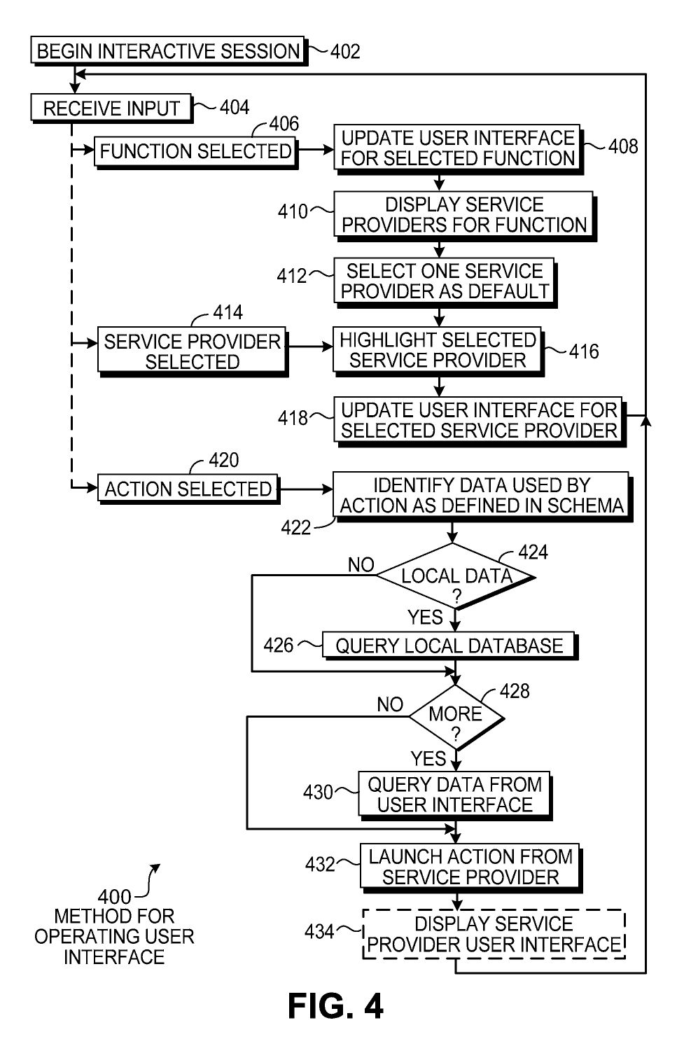

FIG. 4 is a flowchart illustration of an embodiment 400 showing a method for operating an interactive user interface. Embodiment 400 is a simplified example of a method that may be performed by a user interface manager when a user interacts with the user interface, such as the user interface may be prepared in embodiment 300. Embodiment 500 illustrates an embodiment for updating the user interface when a service provider is selected, which is illustrated in embodiment 400 as a single block.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 is an example of some of the operations that may be performed while a user interacts with the user interface of a service provider management system. The user interface may be defined by the process of embodiment 300 and, in some cases, may resemble the user interface of embodiment 200.

In block 402, an interactive session may be started. Block 402 may correspond with block 326 in some embodiments. In a typical interactive session, a user may browse through different aspects of a user interface to view different service providers and the data associated with the service providers.

In order to simplify the embodiment 400, three different interactions are illustrated. The user may browse between functions or service providers, and may select an action to launch. Other embodiments may have additional functions or capabilities.

In block 404, a user input may be received. In a typical graphical user interface, the user may input a selection by clicking on a mouse, for example. A user may produce input using any type of input device, depending on the embodiment. In a command line user interface, a user may use a keyboard as interface, while a touchscreen may be used on a mobile device such as a cellular telephone.

When the user selects a function in block 406, the user interface may be updated for the selected function in block 408. The service providers for the selected function may be displayed in block 410, and one of the service providers may be selected as a default service provider in block 412.

The default service provider in block 412 may be the last used service provider or the most used service provider in the selected function. In some embodiments, a default service provider may not be selected.

When a service provider is selected in block 414, or when the default service provider is selected in block 412, the selected service provider may be highlighted in block 416.

The user interface may be updated for the selected service provider in block 418. Embodiment 500 described later in this specification may describe on embodiment for updating the user interface for the service provider. In many embodiments, a list of available actions may be defined, along with current data for the service provider. The available actions and current data may be displayed in the user interface in block 418.

After the user interface is updated in block 418, the process may return to block 404 for another user input.

When a user selects an action in block 420, an action may be launched with the service provider. An action may be implemented in several different manners. In some cases, the service provider management system may gather information and transmit a command, script, or other information to a service provider to process. The service provider may return with an updated status.

In some cases, the service provider management system may gather information and transmit a command, script, or other information which may spawn a second user interface that may be created by the service provider. The user may perform additional operations directly with the service provider without using the service provider management system user interface. Once operations with the service provider are completed, control may be passed back to the service provider management system user interface for further operations.

After selecting an action in block 420, data used by the action may be identified in block 422. The schema may define the specific information used by a service provider for the indicated action. For example, an action to create a new user account may have a schema definition that includes a user name and credentials for the new account.

In block 424, if the data is available locally, the data may be retrieved by querying a local database in block 426. In some cases, the local database may be an LDAP or LDAP-like database used for storing user and device specific data. Any database or location for data may be used in block 426. In some cases, the query in block 426 may involve reading a local configuration file, performing a query to an executing service, or performing some other data collection operation.

In block 428, if additional data may be sought, a user interface may be presented in block 430 and the user may enter the additional data. In block 430, the user interface may be a component of the service provider management system.

After all the data are collected in blocks 426 and 432, the action may be launched with the service provider in block 432. The action may be transmitted to the service provider in many different manners. In some cases, a script may be created that defines the operation to perform, and the script may include the gathered data from blocks 426 and 430 or contain pointers to the gathered data. The script may be transmitted to the service provider which may cause an action to be completed.

In some cases, the collected data may be transmitted to the service provider using a messaging system or other communication mechanism. The service provider may launch a second user interface in block 434 through which additional data may be collected or a status of the action may be presented. In some cases, the user may interact with the service provider user interface for a considerable time with different types of interaction to complete whatever task is desired.

After the action is completed in block 432 and 434, the process may return to block 404 for another user input.

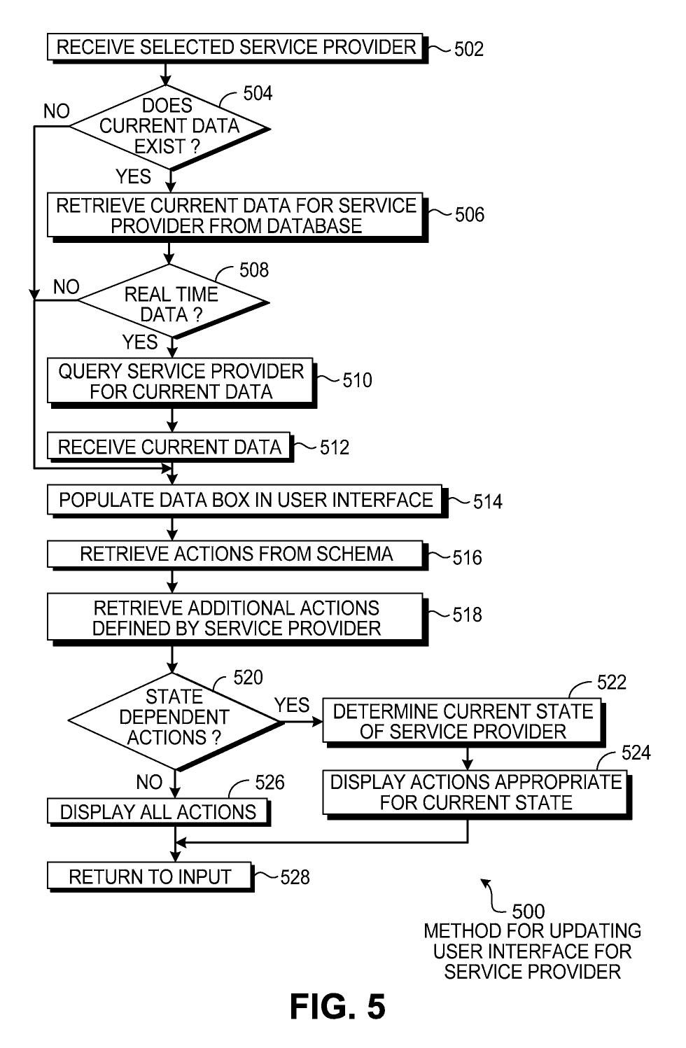

FIG. 5 is a flowchart illustration of an embodiment 500 showing a method for updating a user interface when a service provider is selected. Embodiment 500 is an example of the operations that may be performed in block 418 of embodiment 400.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 500 is an example of the process that may be performed to update a data box and action box of a user interface, such as the data box 228 and action box 226 of embodiment 200.

The selected service provider may be received in block 502.

01241 If current data exists for the selected service provider in block 504, current data for the service provider may be retrieved from a database. In some embodiments, a database of installed service providers may be maintained, such as the database 126 described in embodiment 100. When a selected service provider does not have such data, such as when the selected service provider is not installed, the process may jump to block 514 below.

If the service provider has real time data in block 508, the service provider may be queried in block 510 for the current data, which may be received in block 512.

The data box in the user interface may be populated with the current data in block 514.

The actions for the function may be retrieved from the schema in block 514. In block 516, any additional actions defined by the service provider may also be retrieved.

In some embodiments, the actions presented to a user may be state dependent. For example, an uninstalled service provider may have an action for installing the service provider or performing an initial configuration. Once the initial configuration is complete, additional actions may be presented. Such an operation may have actions dependent on the state of the service provider.

If state dependent actions exist in block 520, the current state of the service provider may be determined in block 522 and the actions appropriate for the state may be displayed in block 524. If no state dependent actions are present in block 520, all actions may be displayed in block 526.

Once the actions are displayed in blocks 524 or 526, the process may return to collect user input in block 528.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method being performed on a computer processor, said method comprising:
receiving a list of service providers for a plurality of functions;
for a first function, identifying a set of said service providers for said first function;
for each of said service providers for said first function, receiving a set of data conforming to a schema, said schema comprising service provider identifiers;
presenting at least some of said service provider identifiers in a user interface;
receiving a selected service provider from said user interface;
presenting a set of actions corresponding with said selected service provider on said user interface;
receiving a selected action from said user interface;
populating at least a portion of said schema corresponding to said selected action; and
causing said selected action to be performed.

2. The method of claim 1, said list of service providers being received from a server comprising a catalog of service providers.

3. The method of claim 1, said list of service providers comprising installed service providers and alternative service providers, each of said service providers in said list being capable of performing at least a portion of said first function.

4. The method of claim 1, said first function being a messaging function.

5. The method of claim 4, said messaging function comprising electronic mail.

6. The method of claim 5, said messaging function being performed for a managed device.

7. The method of claim 1 further comprising:
performing a query to a user database to determine user specific data; and
using said user specific data to populate said at least a portion of said schema.

8. The method of claim 7, said user database being a Lightweight Directory Access Protocol database.

9. The method of claim 7, said user specific data comprising a user identifier.

10. The method of claim 9, said portion of said schema comprising administrator credentials for said selected service provider.

11. A system comprising:
a set of functions to be managed, said functions being provided to client devices;
for each of said functions, a service provider interface for said function, said service provider interface comprising schema defining common data;
a user interface manager configured to perform a method using a computer processor, said method comprising:
for a first function, identifying a set of said service providers for a first function;
for each of said service providers for said first function, receiving a set of data conforming to a schema, said schema comprising service provider identifiers;
presenting at least some of said service provider identifiers in a user interface;
receiving a selected service provider from said user interface;
presenting a set of actions corresponding with said selected service provider on said user interface;
receiving a selected action from said user interface;
populating at least a portion of said schema corresponding to said selected action; and
causing said selected action to be performed.

12. The system of claim 11, said user interface comprising a selection mechanism to select between said functions.

13. The system of claim 11, said user interface comprising a current data area, said user interface manager further configured to:
perform a query to at least one of said client devices;
receive current data; and
present said current data in said current data area.

14. The system of claim 11, said user interface comprising a current data area, said user interface manager further configured to:
perform a query to said selected service provider;
receive current data; and
present said current data in said current data area.

15. The system of claim 11, said set of selected actions comprising at least one action defined by said service provider.

16. The system of claim 11, said selected action comprising provisioning said function for at least one of said client devices.

17. The system of claim 11 further comprising:
a function database comprising said set of functions to be managed for said client devices.

18. A method performed on a computer processor, said method comprising:
receiving a set of functions to manage;
for each of said set of functions, receiving a function schema;
for a first function, identifying a plurality of service providers capable of providing said first function, each of said plurality of service providers being compatible with said function schema;
identifying a first set of service providers for said first function, said first set being installed service providers;
identifying a second set of service providers for said first function, said second set being not installed service providers;
presenting said first set of service providers and said second set of service providers in a user interface;
receiving a first user input identifying a first service provider, said first service provider being an installed service provider;
identifying a set of data relating to said first service provider;
presenting said set of data in said user interface;
identifying a set of actions for said first service provider;
presenting said set of actions in said user interface;
receiving a second user input identifying a first action, said first action having a set of data defined in said function schema;
populating at least one parameter in said set of data; and
causing said first action to be performed.

19. The method of claim 18, said first set of service providers being visually grouped with respect to said second set of service providers in said user interface.

20. The method of claim 18 further comprising:
launching a second user interface provided by said first service provider to perform said first action.
